(19) United States
(12) Patent Application Publication
(10) Pub. No.: US 2003/0055577 A1
(43) Pub. Date: Mar. 20, 2003

(54) Method and system for approximating properties of laser interaction with materials

(76) Inventors: Andreas Gartner, Melbourne, FL (US); Anthony Pappalardo, Palm Bay, FL (US)

Correspondence Address: Andreas Gartner and Anthony Pappalardo, ACA Precision Technology, Inc., 4450-L Enterprise Court, Melbourne, FL, 32934, US

(21) Appl. No.: 10/211,916

(22) Filed: Aug. 1, 2002

Related U.S. Application Data
(63) Continuation-in-part of application No. 09/782,465, filed on Feb. 13, 2001, now abandoned.

(51) Int. Cl. G06F 19/00; G01N 31/00

(52) U.S. Cl. 702/32

(57) ABSTRACT

A method to approximate descriptive parameters of an interaction of a coherent light source with an arbitrary wavelength and energy mode with an arbitrary material of known properties, the method comprising providing a data file with characteristics of the coherent light source, providing a data file with characteristics of the material, providing a data file describing a resolution of a subset of the material, and calculating at least one of an energy distribution and a beam projection of the coherent light source specific to the material with a parallel processing technique.

### SPECIFIC DATA RELATED TO THE INVENTION

This application is a continuation-in-part of U.S. non-provisional application Ser. No. 09/782,465, filed Sep. 1, 2000.

### BACKGROUND OF THE INVENTION

This invention relates to computer modeling of physical objects, and more particularly to modeling physical objects to determine a specific energy distribution and beam projection of a laser for cutting the physical object.

Currently; when a laser is used to cut a new type of material, an empirical approach is used wherein samples of the material are cut with a laser at different energy distribution and beam projection settings until an acceptable setting is determined. Such an approach may involves a high quantity of samples of material, and the cost to operate the laser may be excessive for each sampling. Thus industries that rely on lasers to cut materials would benefit from a method that minimizes and/or avoids using an empirical approach to determine a laser beam's specific energy distribution and beam projection specifications for cutting a given type of material.

One way to avoid using an empirical approach is to apply a model simulation of the laser beam, or coherent light source to the material. The central theme of the modeling of physical effects on real-world objects is the concept of data abstraction and inheritance. The data abstraction part of the model attempts to find a class of objects defining the state of its member data and the behavior of the object as its member functions. In an abstract data structure they are organized in a coherent unit. The inheritance relation enables factoring of common parts for the definition of a more general base class higher in the class hierarchy.

The basic concept of the finite difference method is the use of Taylor series expansion of the function. There are several methods of approximating the derivative at a given point by finite differences. A frequently used method for the approximation of numerical solutions of differential equations is the method of finite difference approximation of partial derivatives. This method is considered approximate in that the derivative at a given point is represented by the derivative taken over a finite interval across the point. The accuracy can be controlled by choosing the interval as small as possible at the expense of increased labor in solving the resulting increased number of algebraic equations. The limitation with this method is that stability considerations restrict the size of time steps for a given value of x. If the space steps x are to be chosen rather small to improve accuracy and the calculations span over a large period of time, computational problems become enormous. In such a case, an implicit method has to be used. Crank and Nicolson suggested a modified implicit method of finite differences in which an arithmetic average is taken of the right hand side of the explicit form of the heat conduction equation. The Crank Nicolson method requires a simultaneous solution of all equations for each time step; that is, if there are N internal mesh points (“nodes”), this gives N simultaneous algebraic equations for the N unknown temperatures for each time step. Hammond, U.S. Pat. No. 4,787,057, teaches aspects of matrix manipulations in multiprocessor environments, which provide a general background for scientific computing of large systems of equations, which differ greatly from today's methods.

The resulting representation of temperature values enables a determination of axial and shear stress as well as in general displacement values in a certain plane of the object. The preferred solution for such problems is a method of finite elements. A subset of this method, a displacement based analysis, based on a principle of virtual work is a basic relationship used for the finite element formulation. Shugar et al, U.S. Pat. No. 4,742,473, as well as Roth, U.S. Pat. No. 5,289,567, appear to teach using this approach. Meshkat et al., U.S. Pat. No. 4,933,889, teaches methods for a fine decomposition in mesh generation and Osano, U.S. Pat. No. 5,442,569, appears to teach a systemic characterization, while Dasgupta, U.S. Pat. No. 6,101,450, apparently teaches a stress analysis in defect free four node technique. However currently as presently done to model an object to be cut with a laser beam of an arbitrary energy distribution and an arbitrary beam projection profile requires a high speed computer which may take about one day to calculate one set of data.

To apply a principle of virtual displacement, equilibrium of a body requires that for any compatible small virtual displacements imposed on the body in its state of equilibrium, the total internal work is equal to the total external virtual work, hence balancing the system. “Virtual” denotes that the displacements, and corresponding virtual strains, are not “real” displacements which the object actually undergoes as a consequence of a thermal load. Instead, the virtual displacements are totally independent from the actual displacements and are used to establish the internal equilibrium condition only.

### BRIEF SUMMARY OF THE INVENTION

Towards this end, the present invention is directed to a method and system for approximating descriptive parameters of an interaction of a coherent light source having an arbitrary wavelength and energy mode with an arbitrary material of known properties. In one preferred embodiment the method comprises providing a data file with characteristics of the coherent light source, a data file with characteristics of the material, and a data file describing a resolution of a subset of the material. Using a parallel processing technique, energy distribution and a beam projection of the coherent light source specific to the material is calculated and reported to a user.

In another preferred embodiment, also using a parallel processing technique, the method comprises determining physical and elemental characteristics of the material, and properties of the light source. The material is then divided into a plurality of subsets. An array based on thermal-mechanical, or temperature characteristics of a subset at a specific time is built and element matrices are built from the array. Load vectors based on the array are calculated. A material-specific matrix, such as a stiffness matrix, based on the characteristics of the subset at a specific time is built. The light source properties are applied to the element matrices and material-specific matrix wherein the processor calculates a displacement of the subset and a stress of the subset. This information is reported to a user.

Similarly, a system is disclosed wherein a first data file containing information about the coherent light source, a second data file containing information about the material, and a third data file containing information about a resolution of a subset of the material is provided. A processor which evaluates the information contained in the first, second, and third data file using a parallel processing technique to determine an energy distribution and/or a beam projection of the coherent light source specific to the material also comprises the system.

### BRIEF DESCRIPTION OF DRAWINGS

The features of the invention are set forth with particularity in the appended claims. The invention itself, both as to organization and method of operation, may best be understood by reference to the following description in conjunction with the accompanying drawings in which like numbers represent like parts throughout the drawings and in which:

FIG. 1 is a block diagram of exemplary elements of the present invention;

FIG. 2 is an embodiment of a flow chart illustrating exemplary steps disclosed in the present invention;

FIG. 3 illustrates an exemplary embodiment of a global array and a matrix;

FIG. 4 illustrates the use of mesh ghost cell communication; and

FIG. 5 is an embodiment of a flow chart illustrating exemplary steps disclosed in the present invention.

### DETAILED DESCRIPTION OF THE INVENTION

With reference to the figures, exemplary embodiments of the invention will now be described. The scope of the invention disclosed is applicable to a plurality of modeling techniques used to determine a specific energy distribution and beam projection of a laser used to cut a physical object. Thus, even though embodiments are described specific to a preferred embodiment, one skilled in the art will recognize how the invention is also applicable to other modeling techniques.

FIG. 1 is a block diagram of exemplary elements of the present invention. As illustrated in FIG. 1, a processor using parallel processing is used to calculate data about the laser beam and the material it is impinging. A laser, or coherent light source, 5 projects a laser beam, or beam of light, 10 with a known energy distribution in the beam and projection profile impinges on the surface of a material 12 of known properties and moves along a certain path on such surface in a certain known speed, which in most cases will be but ultimately does not have to be constant. The coherent light source 5 can be, but is not limited to, a nuclear, electrical, chemical, and/or infrared radiation source. Energy is transferred from the laser beam 10 to the material 12, in a rate as determined by the relative displacement of the beam projection on the surface of the material 12, the initial laser power, the reflectivity characteristics of this particular material as well as the thermal and mechanical material properties. In one preferred embodiment, the present invention assumes that the material 12 is opaque to the specific wavelength of the coherent light 10 as to absorb the entire energy remaining after a certain part is reflected on the surface. A material 12 which is partly transmissive to a specific wavelength can be analyzed accordingly as the transmission coefficient can be used to correct the initial energy balance. A processor 14 is also disclosed. In a preferred embodiment, the processor 14 uses a parallel processing technique to perform its modeling tasks, utilizing data files with information, or characteristics specific to the laser beam, or coherent light source, and the material. In a preferred embodiment, these data files are saved in a storage device 16 integrated with the processor 14.

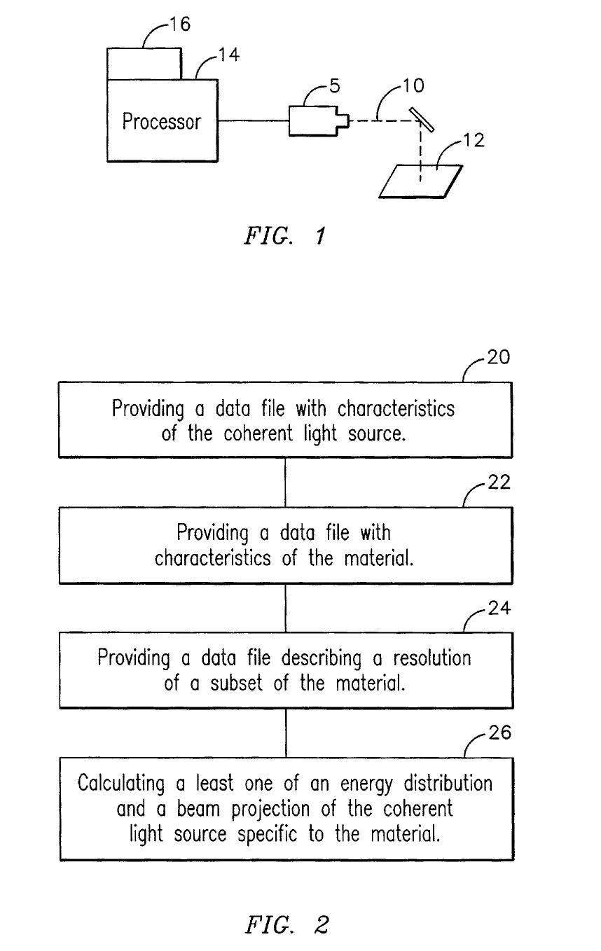

FIG. 2 is an embodiment of a flow chart illustrating exemplary steps disclosed in the present invention. A data file with characteristics of the coherent light source is provided, step 20. The energy distribution in the beam projection on the surface of the material is modeled in a two dimensional descriptor which describes the energy distribution of the beam 10 in a sequence of single byte values denoting the energy level in a range from 0 to 255. In other words, a file is written modeling the beam's 10 energy flux where intensity levels are assigned values between 0 to 255. The resolution of such a description is arbitrary as the processor 14 incorporates a fuzzy logic based algorithm to adopt the specific resolution to the nominal resolution of the desired result matrix. In a preferred embodiment, the initial data is provided in form of a batch file where as a first subset the process data is given.

The process data in this first subset comprises the pointer to the relevant description of the beam projection, the power of the laser (with or without correction for the transmissivity of the optical system and a caused power loss), the speed of displacement of the beam projection in its specific physical dimension on the surface of the material, flow characteristics of the balance system including the specific heat data of the medium used in the balance system, the geometry of the balance system relative to the heat flux system as well as the path descriptor. The path descriptor is an entity which gives a complex description of the starting point of the interaction relative to the absolute coordinates of the material in its specific shape and dimension, the geometry of the path, so whether the path runs straight along a non-spherical surface to a specific end point coinciding with or outside the physical boundaries of the material, or runs in for example a circular path inside the material boundaries. A combination of different subsets of the path descriptor is incorporated, allowing a commutative or non-commutative segmenting of the path in its entirety. This segmenting establishes the possibility to have for example different relative displacement rates or different power levels in specific subsets, which in their combination result in a description of the path and the relevant describing parameters. In one preferred embodiment, more than one path descriptor is used for the heat flux as well as balancing system. The heat flux and balance system also consists of multiple descriptors, reflecting the ability to run multiple simultaneous beams and balance projections on the material.

A second subset is provided, step 22, in the processor consisting of the material properties, insofar as they describe the specific heat, thermal capacity, thermal expansion, strain point, Young Modulus and Poissan ratio of a given material under analysis. A third subset, step 22, describing the physical dimension and thickness of the material is also provided in the processor. A fourth subset describing the resolution of the required result matrix by defining a volume element called the “materialet” or nodel point or subset, which not only governs the resolution of all subsequent processes but also is used to correct all dependent projections or better their descriptions is also provided, step 24, in the processor regarding the material under analysis. The materialet is the smallest discrete unit of the material in three dimensions.

All these parameters are either retrieved from a material property database, process parameter database, or entered in the batch file if no pre-existent analysis condition is used. The number of descriptions in a batch file is not limited, and the code subsequently runs until it encounters an end of field marker.

An energy distribution and a beam projection of the coherent light source specific to the material is calculated, step 26. Using the resolution as a scaling vector, an original matrix of initial temperatures in volume elements is built and systems of partial differentiation equations are established depending on initial boundary conditions. These systems of equations, and in general a complete mathematical background of the laser interaction with the material are disclosed in patent application Ser. No. 09/435,219 and patent application Ser. No. 09/465,247, incorporated by reference.

Simultaneous algebraic equations for unknown temperatures at a certain time interval are given in terms of known temperatures at a previous time interval. For the generality of the system it is considered subject to boundary conditions at both boundaries. A solution is determined by starting with a time interval of zero. The system becomes a number of algebraic simultaneous equations for the unknown temperatures since the temperature vector on the right hand side of the equations is known from the initial condition. The procedure is repeated for the following time steps. This ultimately results in a solution matrix giving the final temperatures of the materialets in the system for a given energy input as defined by the process parameters.

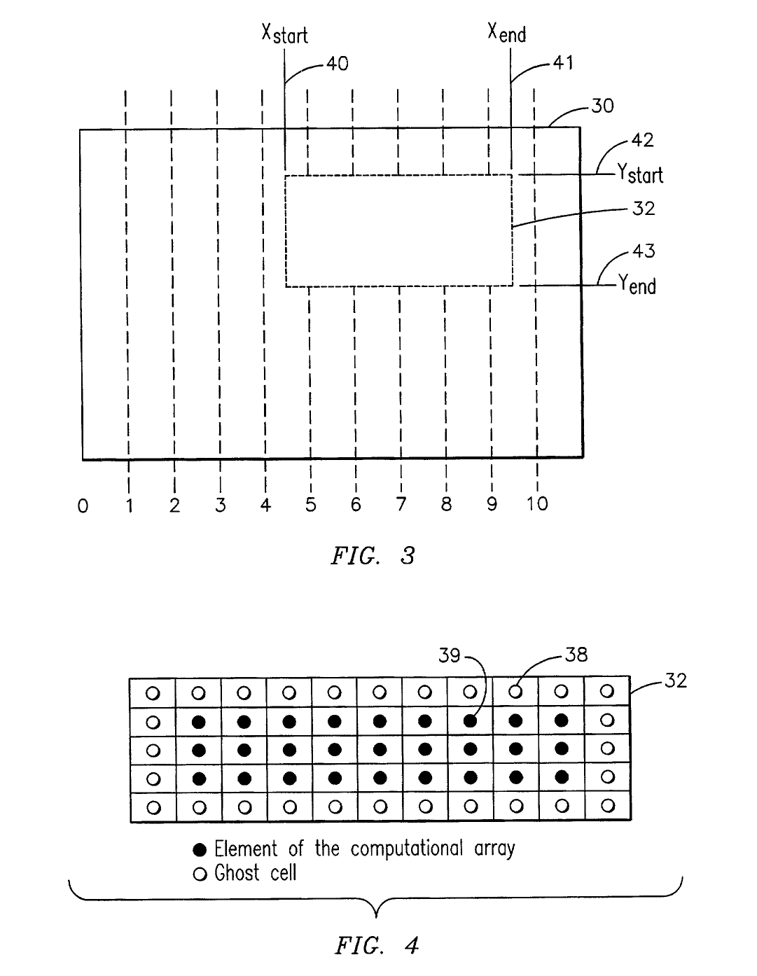

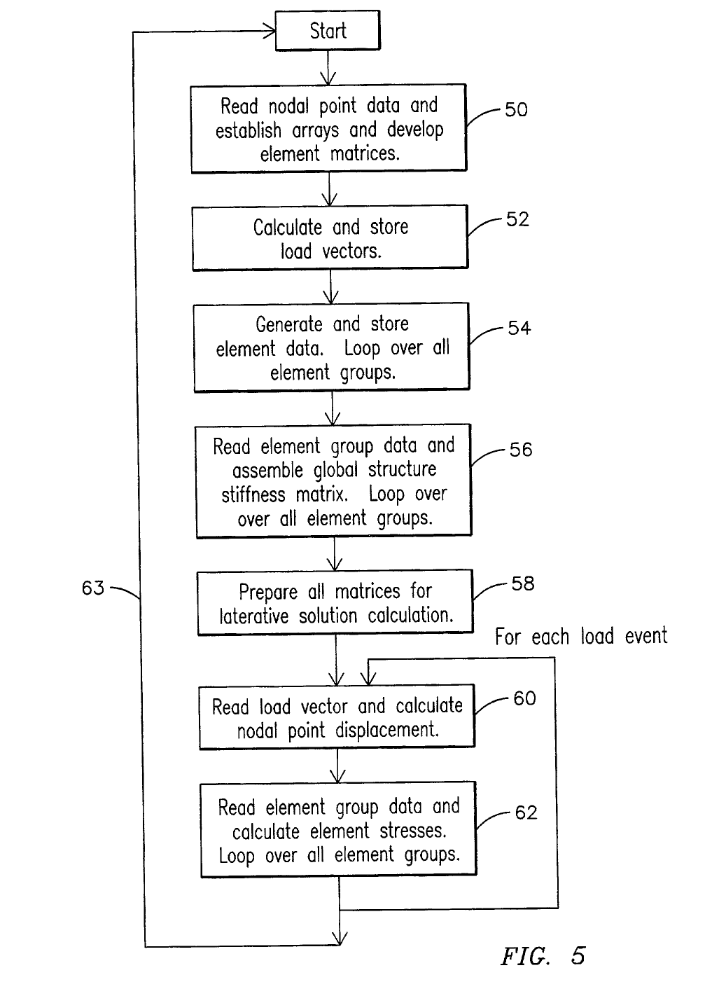

FIG. 3 is an exemplary embodiment of a global array 30, where a segment, or matrix, 32 is identified for calculating a value/values. As mentioned earlier, due to the inherent size of multi-dimensional equations systems which need to be solved simultaneously, a parallel process technique is applied to improve the time it takes to complete the processing. This technique may utilize a single processor 14, a plurality of processors or a plurality of parallel processors. In order to perform the matrix operations outlined above in a node-only (sometimes also referred to as master-slave) process, a group of processes stored in a distributed memory of a parallel computation system is provided. This set of processes is considered to form a mesh. This mesh mirrors a similar mesh which has been dynamically applied to the matrix, effectively forming subsets of this matrix. Each subset 32 of the initial matrixes 30 is sent to a process, by utilizing efficient data decomposition models. To compute the description at every point on the part of the mesh that is local to the individual process, the value of the neighboring point is needed, which are called ghost cells 38, as illustrated in FIG. 4. To better understand ghost cells 38, the shaded elements 39 are the elements contained between boundaries Xstart 40, Xend 41, Ystart 42 and Yend 43 of FIG. 3. The non-shaded elements, or ghost cells 38, are the elements immediately before, or adjacent to, the elements which are first encompassed by the defining boundaries of the subset 32. An algorithm is implemented for communicating the neighbor information to the ghost cells 38. During computation, subsets 32 are forwarded or exchanged between processes, thereby transforming the original allocation map. At the end of the computation, however, result matrix blocks are situated on the individual process, in conformance with their respective positions on the process grid and are consistent with the data partition map of the result matrix.

The calculation continues with the evaluation of a stiffness matrix of a materialet, or subset. In order to derive a stiffness matrix, in a preferred embodiment a strain displacement matrix is calculated first. Stresses are assumed to be known quantities and are unique stresses that balance an applied load. Virtual strains are calculated by the differentiations from assumed virtual displacements. In a preferred embodiment, the virtual displacements represent a continuous displacement field. All integrations are performed over the original volume and surface of the object or given material, unaffected by the imposed virtual displacements.

To exemplify the use of this principle, assume to have been given the exact solution of the displacement field in a body. This given displacement field is continuous and satisfies the displacement boundary conditions. The strain and stress corresponding to the displacement field are then calculated. The stress vector lists the correct stresses if and only if the initial equation holds for any arbitrary virtual displacements that are continuous and zero and corresponding to the prescribed displacements on the initial area.

The element strains are obtained in terms of derivatives of element displacement with respect to a local coordinate system, such as derivatives ∂x, ∂y and ∂z, and use the chain rule to obtain the relevant forms. However, to obtain ∂x, evaluation of explicit inverse relationships is also required. This introduces the Jacobian operator in the calculation, which relates the natural coordinate derivatives to the local coordinate derivatives. The inverse of the Jacobian operator exists provided that there is a unique correspondence between the natural and the local coordinates, which only for the case that the element is much distorted or folds back upon itself is not given. But even such singularities in the Jacobian operator can be dealt with. Now the calculation is possible and construction of the strain displacement matrix B with help of a vector listing the point displacements for the individual materialet is possible. The element stiffness matrix corresponding to the local element degrees of freedom is provided as the volume integral over the product of the transverse of the strain displacement matrix, BT, the constant material property matrix and the strain displacement matrix B. The elements of matrix B are functions of the natural coordinates. Therefore the volume integration extends over the natural coordinate volume and the volume differential is also written in terms of natural coordinates.

Since an explicit evaluation of the volume integral may not be effective, particularly when higher order interpolations are used, numerical integration is employed. Even though using full numerical integration with a predefined integration order will not yield exactly integrated element matrices for geometrically distorted elements, the analysis is, however, reliable because the numerical integration errors are acceptable small assuming reasonable geometric distortion. It has been shown by P. Ciarlet that if the geometric distortions are not excessive and are such that in exact integration the full order of convergence is still obtained then the same order of convergence is also obtained using full numerical integration. Hence, in such a situation the order of numerical integration as employed according to this invention does not result in a reduction of the order of convergence. The reason for using numerical integration here is that the reliability of these procedures is of utmost concern and if an integration order lower than the “full” order is used for the calculation of displacement based formulations the analysis is in general more unreliable.

FIG. 5 is an embodiment of a flow chart illustrating exemplary steps disclosed in the present invention. Thus, in operation and as illustrated in FIG. 5, beginning at a time, T0, (immediately before calculating values once a coherent light source, or laser is applied), the processor will read a materialet, or nodal point, or subset data to determine temperature, or thermal-mechanical values. With this data, it will establish an array, and element matrices, step 50. Since each array is considered as a one-dimensional vector, the processor will next calculate and store load vectors, step 52. The data calculated is then stored, step 54. This first part of the process is performed for all element groups or nodal points, step 54. Next, the processor accesses the data file containing element group data and assembles a global structure stiffness matrix, the physical property matrix for each nodal point, step 56. All matrices are now ready for interactive solution calculations, or in other words, applying the laser beam data file characteristics specific to how the laser beam will interact with each nodal point, step 58. Now for each load, the process will calculate nodal point displacement, step 60, and calculate element stresses, step 62 for each nodal point. The process is then repeated, step 63 for the next time interval, T1.

While the invention has been described in what is presently considered to be a preferred embodiment, many variations and modifications will become apparent to those skilled in the art. Accordingly, it is intended that the invention not be limited to the specific illustrative embodiment, but be interpreted within the full spirit and scope of the appended claims.

What is claimed is:

1. A method for approximating descriptive parameters of an interaction of a coherent light source with an arbitrary wavelength and energy mode with an arbitrary material of known properties, the method comprising:
providing a data file with characteristics of the coherent light source;
providing a data file with characteristics of the material;
providing a data file describing a resolution of a subset of the material; and
calculating at least one of an energy distribution and a beam projection of the coherent light source specific to the material with a parallel processing technique.

2. The method of claim 1 wherein the step of calculating further comprises calculating a thermal characteristic of the material.

3. The method of claim 1 wherein the step of calculating further comprises calculating a mechanical characteristic of the material.

4. The method of claim 3 wherein calculating a mechanical characteristic comprises applying a stiffness matrix to determine a stiffness value of the material.

5. The method of claim 1 wherein the step of calculating further comprises utilizing a plurality of processors to calculate the energy distribution and beam projection.

6. The method of claim 5 wherein utilizing a plurality of processors comprises utilizing a plurality of parallel processors.

7. The method of claim 5 wherein the step of providing a data file with characteristics of the material further comprises providing at least one of a physical dimension and a thickness of the material.

8. The method of claim 5 wherein the step of providing a data files with characteristics of the material further comprises providing material properties.

9. The method of claim 1 wherein the step of calculating further comprises:
establishing an array using resolution data of the subset to determine a temperature of the subset at a specific time;
developing an element matrix to determine the temperature;
calculating a load vector to determine the temperature;
storing the calculated load vector;
applying characteristics of the coherent light source to the calculated load vector;
calculating the subset displacement; and
reporting the subset displacement to a user.

10. The method of claim 1 wherein the step of calculating further comprises:
assembling a stiffness matrix;
applying characteristics of the coherent light source to the stiffness matrix;
calculating subset stresses; and
reporting the subset stress to a user.

11. A system to approximate descriptive parameters of an interaction of a coherent light source with an arbitrary wavelength and energy mode with an arbitrary material of known properties, the system comprising:
a first data file containing information about the coherent light source;
a second data file containing information about the material;
a third data file containing information about a resolution of a subset of the material; and
a processor which evaluates the information contained in the first, second, and third data file using a parallel processing technique to determine at least one of an energy distribution and a beam projection of the coherent light source specific to the material.

12. The system of claim 11 further comprising a coherent light source.

13. The system of claim 12 wherein the coherent light source is at least one of a nuclear, electrical, chemical, and infrared radiation source.

14. The system of claim 11 wherein the processor is at least one of a single processor, multiprocessor and a plurality of parallel processors.

15. The system of claim 11 further comprising a storage device integrated with the processor.

16. A method for determining descriptive parameters of an interaction of a coherent light source with a material with a parallel process technique, the method comprising:
determining physical and elemental characteristics of the material;
determining properties of the light source;
dividing the material into a plurality of subsets;
establishing an array based on thermal-mechanical characteristics of a subset at a specific time;
developing element matrices using the array;
calculating load vectors based on the array;
developing a material-specific matrix based on the characteristics of the subset at a specific time;
applying light source properties to the element matrices and material-specific matrix;
calculating a displacement of the subset;
calculating a stress of the subset;
reporting at least one of the displacement of the subset and the stress of the subset to a user.

17. The method of claim 16 wherein developing a material-specific matrix step further comprising developing a stiffness matrix.
